(19) United States
(12) Patent Application Publication
(10) Pub. No.: US 2010/0061619 A1
(43) Pub. Date: Mar. 11, 2010

(54) METHOD AND DEVICE FOR THE RECOGNITION OF AN AUTHENTICATING MARK ON AN ENVELOPED SURFACE OF AN OBJECT

(75) Inventor: Charles Boegli, Marin (CH)

Correspondence Address: FOLEY AND LARDNER LLP;SUITE 500, 3000 K STREET NW, WASHINGTON, DC, 20007, US

(73) Assignee: BOEGLI-GRAVURES S.A.

(21) Appl. No.: 12/598,539

(22) PCT Filed: May 2, 2008
(86) PCT No.: PCT/CH08/00204

§ 371 Date: Nov. 2, 2009

(30) Foreign Application Priority Data
May 4, 2007 (CH) 00730/07

(51) Int. Cl. G06K 9/00; G06K 7/10

(52) U.S. Cl. 382/141; 250/271; 977/742

(57) ABSTRACT

A method for the recognition of an authenticating mark on the surface of a packaging foil or an article by visual and/or electronic recognition through an envelope, where ultrasonic or X-ray techniques are performed. The authenticating mark includes at least one embossed authenticating mark having finest structures in the micrometer range, and the surface of the packaging foil or of the area of the article in which the authenticating mark is embossed being metallized or made of metal.

A package need not be opened or destroyed for inspection and the authenticating marks are not distinguishable from the outside in visible light.

The present invention relates to a method and device for the recognition of an authenticating mark that is embossed on a surface of a packaging foil or of an article through an envelope, according to the preamble of claim 1, and mainly also to the authentication of cigarette packages, respective of cigarettes.

An object to be identified whose surface is recognized through an envelope that is impermeable to visible light is known in the art from US 2005/206500 A1. On one hand, the latter refers to relatively large objects and marks, and on the other hand, the employed radiations capable of passing through the envelope are only mentioned but not specified. More particularly, X-rays, different types of RF radiation, RMI technology or an acoustic imaging method are proposed.

DE 36 13 549 A1 discloses a method for reading bar-code information by means of sound waves that makes use of the fact that the bar-code is designed such that the spaces have different transmissive properties.

From EP-B-1 236 192 to the applicant of the present invention it is known to recognize an article by means of at least one authenticating mark that is applied in addition to other security elements, the authenticating marks being embossed by means of an embossing device that produces a special embossing pattern. In the introduction of this patent specification, different documents referring to the production of authenticating marks and elements are cited which consequently will not be enumerated here.

As explained in the specification and in claims 5 and 6 of EP-B-1 236 192, the authenticating mark should be recognized through the cigarette packet and more particularly through a corresponding window in the cigarette packet. However, an indication of a concrete method for recognizing the features through the package is not given in this reference.

According to EP-A-1 216 819, marks that are embossed on a first layer are read through windows in a second layer, the layers being cigarette packaging foils.

Similar authenticating marks may also be provided on packaging foils for foods such as chocolate or butter or for other articles—e.g. from the pharmaceutical industry, such as capsules or pills—or else for objects such as PC cards, that are to be recognized through a package of cardboard or the like.

Another problem area is the authentication of timepieces, more particularly wrist or pocket watches. In order to be able to recognize the authenticating marks, the latter have to be applied to the housing externally or the timepiece has to be opened, which generally requires specialized personnel. Therefore, a recognition through the dial or through the bottom would be very advantageous.

Recently, methods and devices for embossing ever smaller and thus increasingly fraud resistant authenticating marks have been developed by the applicant, e.g. according to U.S. Pat. No. 7,229,681, and based thereon, it is the object of the present invention to provide a method and a device that allow recognizing even very small security elements such as authenticating marks and/or elements in the micrometer range on the surface of packaging foils around tobacco products, foods, pharmaceutical products or PC components through the package, or on the surface of timepieces through the envelope, e.g. the dial or the bottom, with sufficient accuracy and dependability. This object is attained by the method according to claim 1 and by the device according to claim 15.

The invention will be explained in more detail hereinafter with reference to exemplary embodiments. Representatively for the above-mentioned articles, these examples refer to the authentication of cigarette packets or cigarettes, respectively. The term “authenticating mark” stands for security or authentication features that have been embossed on packaging foils by means of the embossing methods and devices mentioned in the introduction, or according to a conventional method on a part of a timepiece, on one hand, and on the other hand, for the entirety of characteristics that make up the nature of the object that is to be examined, such as e.g. embossing patterns on identical or different packaging foils.

The term “envelope” stands for packages of cardboard or paper that are impermeable to visible light and in the case of timepieces for dials or watch bottoms made of a material that is permeable to the applied sound waves or rays.

In EP-B-1 236 192, cited in the introduction, different commercial levels are defined, and these are incorporated, as far as they are applicable to the present invention, into the present description as part of an exemplary embodiment.

According to US 2007/0289701 A1, the method according to EP-B-1 236 192 can be further developed in that an array of authenticating marks is embossed as a pattern on-line, read by a suitable apparatus, and evaluated by means of an image processing method. With regard to the embossing pattern, all known embossing types can be applied. In addition to the embossing apparatus, the device used for carrying out the method comprises a reading unit and an evaluating unit. In particular, this method reducing the requirements with respect to the embossing or reading quality without prejudicing the required safety.

According to the prior art, as mentioned in the introduction, either relatively large objects are recognized through an envelope or the mentioned articles are read and recognized directly, which implies that the package must be opened to access the foil or the article in order to be able to read the authenticating marks. The proposal to recognize the articles through a window in the package makes the manufacture more expensive as the window must be manufactured additionally, and the local application of the features is furthermore limited by the location of the window. This also applies analogously when the article is a timepiece.

In order to recognize ever smaller structures through a light-impermeable envelope, it is apparent to one skilled in the art in view of the prior art cited in the introduction that the radiation or the sound waves that are to be applied must be capable of resolving such structures. However, this knowledge alone is not sufficient for attaining the intended object. On the contrary, this requires the realization that there must be an interaction between a particular surface of the article and the adapted sound waves or radiation.

There are essentially two ways of using the sound waves for detection purposes, namely in transmission mode or in reflection mode. In view of the fact that the sound waves or rays have to pass through the envelope first to subsequently produce a useful signal, it has been recognized that the detection signal obtained through reflection offers advantages when the reflecting surface is metallized or metallic, e.g. a metallized packaging foil or an aluminum foil.

Recently, ultrasonic apparatus having a high resolution of less than 0.1 mm have been developed, thereby also allowing to resolve and thus recognize the authenticating marks and elements that are being considered here and have been referred to above. Such an ultrasonic camera is disclosed in a publication that is accessible in the Internet and can be downloaded under the title “Optel Ultrasonic Technology/Fingerprint recognition”.

Another publication from the year 2004, entitled “ultrasonic microscopy”, of the Technical University of Dresden describes an apparatus with a transducer having a nominal frequency of up to 230 MHz, thereby achieving a lateral resolution of up to 10 μm. According to one of these methods, i.e. the so-called impulse echo technique, the surfaces or indentations to be examined are scanned by means of a suitable transducer and a three-dimensional image of the inspected area is reconstructed through an evaluation of the amplitude, the phase, and the delays of the backreflected signals.

Digital signal processing and image processing methods may also be applied to this end. The latter may be used to separate the image areas of interest and to extract the relevant information, respectively. In this regard, additional correlation methods may be applied for a better extraction of certain hidden patterns.

According to EP-A1-1 437 213 to the applicant of the present invention it is possible to modify the teeth of embossing rolls in such a manner that macro- and microstructures are produced which are transmitted to the metallized surface of the packaging foil in the embossing procedure. Such a technique allows embossing the authenticating marks and elements with macro- or microstructures that have been mentioned in the introduction.

These authenticating marks or elements must then be readable by the ultrasonic apparatus in reflection mode through the package. To this end, a suitable sonic transducer will be used that is capable of reading the structures, i.e. the authenticating marks or elements, in the desired frequency range. More specifically, a sonic transducer having a nominal frequency comprised in a range of 5 to 500 MHz can be used, thereby allowing to achieve a large bandwidth of the resolving capacity, which is necessary depending on the structure and size of the authenticating marks. Furthermore, the ultrasonic beam should be focused and directed such that it may reach the features through the package without excessive losses and its backreflected rays can be detected.

Authenticating marks may furthermore be produced by differences in the arrangement of teeth, e.g. by individual teeth or groups of teeth of different shapes in the intended locations, e.g. teeth having a round or rounded horizontal projection in the midst of teeth having a rectangular horizontal projection, or different distances between the teeth.

Moreover, authenticating marks may also be produced by creating indentations, deformations or holes on the surface of the packaging foil by tools other than embossing rolls, e.g. by controlled pins or the like.

In the case of timepieces, the authenticating mark is applied to a watch component that is either covered by the dial or by the bottom and is therefore invisible to the eye. In this case, the recognition is achieved by an adapted ultrasonic or X-rays apparatus through the dial or through the bottom, whose material must be permeable to these sound waves or rays.

Problems might arise when operating at the limit of the resolution, but error corrections may be performed for a reliable recognition of the features, e.g. by means of an adapted mathematical algorithm. In this regard, the above-mentioned method according to CH-01086/06 facilitates the application of an error correction.

An evaluation by means of an adapted mathematical error correction allows an analysis of the embossing pattern, which differs from one embossing roll to another and thus constitutes an identification characteristic of the embossing system. In the embossing process, the surface profile of the embossing roll is transmitted to the paper.

Papers that have been embossed by different embossing rolls differ on a microscopic scale since the surface profiles of different embossing rolls differ from one another without a specific treatment of the teeth of these rolls. These small differences, which serve as the authenticating mark, are to be measured and quantified.

The profile of the embossed paper is not only a function of the embossing roll that has been used but also of the paper properties and of the process parameters adjusted in the embossing process. By means of measurements it has been experimentally shown that the surface profiles of the embossing roll and of the embossed paper differ from one another. Therefore, generally, measurements of embossed papers cannot be related directly to the embossing roll that has been used for embossing but to an embossed reference paper. This reference measurement is periodically renewed in order to compensate for process-related variations. It is therefore an aim to determine, by means of the authenticating mark, i.e. by means of deviations or correlations between the pattern on the paper and that of the embossing roll, whether the paper was embossed by a particular embossing roll.

Theoretical considerations have lead to the assumption that with a refinement of ultrasonic technology, more particularly of the impulse echo method, these small differences could also be detected by means of ultrasonic technology through a package.

However, if these differences are very small, especially in the case of a recognition of differences after embossing with embossing rolls whose teeth have not been altered, they may no longer be detectable through the package by ultrasonic techniques so that another detection method must be applied.

If X-rays are employed, the X-ray apparatus used in the references of the prior art cited in the introduction cannot be applied as they cannot sufficiently resolve the fine structures.

In recent years, developments in X-ray tomography and micro-CT (Computer Tomography) have allowed the creation of X-ray apparatus of the size of a cigarette packet on the basis of carbon nanotubes (CNT). Such apparatus are capable of producing self-focusing measuring spots in the submicrometer range.

Tests have shown that such X-ray microdevices are capable of detecting authenticating marks through a cigarette packet in transmission mode. It is essential therefor that these authenticating marks are applied to a metallized foil or a foil made of aluminum. The effect may be reinforced if the authenticating marks are located in structures such as folds or the like.

In analogy thereto, on a timepiece component, the authenticating marks, i.e. the embossed marks, are identified through the dial or the bottom.

The detection of the rays is achieved by means of suitable semiconductor detectors that are connected to a processing unit of a similar design as that used in the ultrasonic detection of the inspected features.

1. A method for recognition of an authenticating mark on a surface of a packaging foil or an article by visual and/or electronic recognition through an envelope, the recognition method comprising:
performing ultrasonic or X-ray techniques;
wherein the authenticating mark includes
at least one embossed authenticating mark having finest structures in a micrometer range, and
the surface of the packaging foil or of the area of the article in which the authenticating mark is embossed being metallized or made of metal.

2. The method according to claim 1, wherein the packaging foil includes tobacco products such as cigarettes, foods such as chocolate or butter, capsules or pills from the pharmaceutical industry, or PC cards, and wherein the packing foil is enclosed in a package of cardboard, paper, or plastics material.

3. The method according to claim 1, wherein the article is a timepiece and the authenticating mark embossed thereon is recognized through a dial or through the bottom thereof.

4. The method according to claim 1, wherein the ultrasonic technique operates in a range of 5-500 MHz and in reflection mode.

5. The method according to claim 4, further comprising:
employing a impulse echo;
scanning the surfaces or indentations to be examined, by sonic transducer; and
reconstructing a three-dimensional image of the inspection through an evaluation of the amplitude, the phase, and the delays of the reflected signals.

6. The method according to claim 1, further comprising:
identifying in transmission mode using an X-ray apparatus whose radiation can be focused onto a spot in the submillimeter range.

7. The method according to claim 6, wherein the X-ray apparatus operates on the basis of carbon nanotubes delivering radiation spots in the submicrometer range.

8. The method according to claim 1, further comprising
applying digital signal processing and image processing to separate the image areas of interest and to extract the relevant information, respectively.

9. The method according to claim 1, further comprising:
embossing an array of authenticating marks on-line as a pattern; and
using image processing to perform the step of embossing the array of authentication marks.

10. The method according to claim 1, further comprising:
applying additional correlation, the additional correlation configured to extract certain hidden patterns.

11. The method according to claim 1, further comprising:
modifying teeth of the driven embossing roll such that authenticating marks are embossed in the corresponding locations of the packaging foil.

12. The method according to claim 11, wherein no teeth of the driven embossing roll are modified and differences in the embossing pattern that are due to the manufacture of the rolls and/or to the paper quality are used as a authenticating mark, and identified.

13. The method according to claim 1, wherein the authenticating marks are created by differences in the arrangement of teeth, individual teeth or groups of teeth in the intended locations having a different shape, more particularly teeth that have a round or rounded horizontal projection in the midst of teeth that have a rectangular horizontal projection, or the teeth having different distances between them.

14. The method according to claim 1, wherein the authenticating marks are produced by tools other than embossing rolls, e.g. by controlled pins, in the form of indentations, deformations or holes on the surface of the packaging foil.

15. A device for carrying out the method according to claim 1, wherein the device comprises an ultrasonic transducer.

16. The device according to claim 15, wherein the ultrasonic transducer operates in a range of 5 to 500 MHz.

17. A device according to claim 1, wherein the device comprises an X-ray apparatus whose radiation can be focused onto a spot in the submillimeter range.

18. The device according to claim 17, wherein the X-ray apparatus operates on the basis of carbon nanotubes delivering radiation spots in the submicrometer range.
